(19) United States
(12) Patent Application Publication
(10) Pub. No.: US 2009/0006173 A1
(43) Pub. Date: Jan. 1, 2009

(54) METHOD AND APPARATUS FOR IDENTIFYING AND USING HISTORICAL WORK PATTERNS TO BUILD/USE HIGH-PERFORMANCE PROJECT TEAMS SUBJECT TO CONSTRAINTS

(75) Inventors: Robert George Farrell, Cornwall, NY (US); Jianying Hu, Bronx, NY (US); Sarah Campbell McAllister, Baton Rouge, LA (US); Aleksandra Mojsilovic, New York, NY (US); Bonnie Kathryn Ray, Nyack, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/771,387

(22) Filed: Jun. 29, 2007

(51) Int. Cl. G06Q 10/00

(52) U.S. Cl. 705/9

(57) ABSTRACT

A method for identifying and using historical work patterns to build high-performance project teams, in one aspect, may comprise identifying historical data associated with one or more past projects, determining from said historical data, one or more patterns in team member attributes that are correlated with at least one of an individual determined to be successful and a project determined to be successful, and generating one or more staffing plans based on said determined patterns. A system and program storage device for performing finctionalities of the method are also provided.

### FIELD OF THE INVENTION

The present disclosure generally relates to a system and method for using historical work patterns to match people and jobs, to form high-performance teams and increase project success and personal development. More particularly, the present disclosure relates to a system and method that considers prior work patterns together with one or more skills of workers to optimize the allocation of workers to jobs, conduct workforce scheduling and other workforce management actions.

### BACKGROUND OF THE INVENTION

Business success is often based on the caliber of the workforce. However, managing a workforce that is constantly changing in terms of skill distribution, work experience, and other factors, is complex. Project managers, human resource professionals, and other company personnel must manually sort through many hundreds of resumes or employee records to match candidates to new jobs or to staff projects with skilled employees. The successful management of workforce resources under complex business conditions clearly affects customer responsiveness, the ability to deliver goods and services, and the assignee's financial position. Workforce management thus is an important factor in any company's ability to complete project deliverables, grow revenue, and be more profitable.

Some workforce management capabilities include: 1) scheduling workers, teams and shifts (e.g., in call center management or manufacturing), 2) deployment of consultants in services organizations (e.g., assigning individuals to opportunities, staffing new projects), 3) workforce capacity planning (e.g., determining staffing levels that meet the demand in some “optimal” way), 4) workforce gap/glut analysis, gap closure and training, which based on the specified demand, determines excesses and shortages in skills, and recommends resource actions to resolve them. Many software systems and services are designed to support or fully automate some components of this workforce management cycle. Examples include systems for demand forecasting, scheduling, planning tools and budgeting tools.

Many companies are also applying workforce optimization software tools and methods to yield the greatest business value from the available human resources. These software tools and methods often use advanced analytics (e.g., mathematical modeling and optimization) to achieve optimal assignments, typically in terms of meeting some business objectives, such as reduced cost or higher revenue growth. U.S. Pat. Nos. 5,111,391, 5,164,897, 6,049,776, 6,275,812 refer to such workforce management solutions.

Existing solutions optimize the allocation of workers to jobs by taking into account workers' skills, cost of deployment and training, and business objectives. Currently available optimization methodologies and tools designed to match workers to opportunities compute assignments so that overall revenue or profit is maximized or skill gaps and gluts are minimized. However, they fail to capture important aspects of workforce relationships that may contribute to project success. For example, projects may be more successful when staffed with workers that have worked on similar projects. Similarly, more effective teams may be built by taking into account prior working relationships.

High performing project teams drive profitability and client satisfaction for many businesses, especially those with complex product and service portfolios. Thus, it is desirable to have methodologies that exploit workforce patterns and relationships in job scheduling, matching, assignments and team formation. While traditional work management methodologies have been able to match available skills with required skills, there has not been an automated ability that considers prior workforce patterns in order to improve the results of capacity planning, workforce scheduling and other workforce management applications. U.S. Pat. No. 7,103,609 is directed towards the goal of finding high performance teams and evaluating organizational change initiatives, specifically a computer implemented method for evaluating document collections to correlate team behaviors with team performance, evaluate organizational change initiatives, and to encourage other teams to implement behaviors of high-performing teams.

### BRIEF SUMMARY OF THE INVENTION

A method, system and program storage device for identifying and using historical work patterns to build high-performance project teams are provided. The method, in one aspect, may comprise identifying historical data associated with one or more past projects, determining from said historical data, one or more patterns in team member attributes that are correlated with an individual determined to be successful or a project determined to be successful or combinations thereof. The method may further include generating one or more assignments of individuals to projects based on said determined patterns. A system and a program storage device for performing the above-described method are also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a method of the present disclosure in one embodiment.

FIG. 2 is a flow diagram illustrating a detailed processing for identifying and using historical work patterns to build high-performance project teams in one embodiment of the present disclosure.

FIG. 3 illustrates an overview of example system architecture for identifying and using historical work patterns to build high-performance project teams.

### DETAILED DESCRIPTION

A method and apparatus for identifying and using historical work patterns to build high-performance project teams are provided. The method and apparatus in one embodiment combines factors such as the worker attributes, demand for jobs and other requirements of workforce management, with the workforce patterns discovered based on the past workforce relationships and provides work assignments, or plans for improving worker skills (“upskilling”), using an automated methodology.

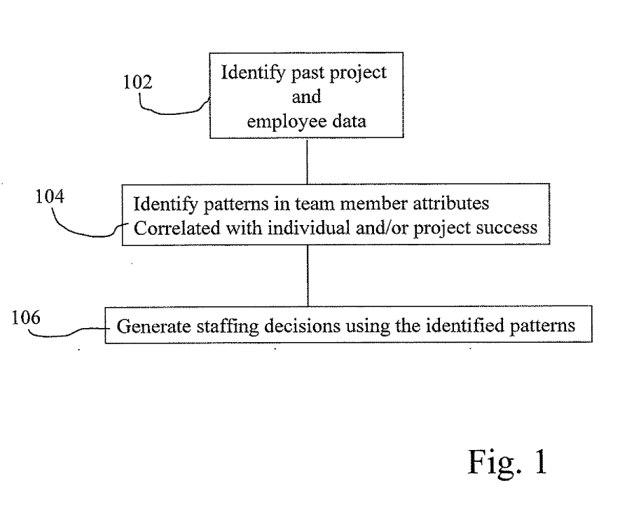

FIG. 1 is a flow diagram illustrating a method of the present disclosure in one embodiment. At 102, historical project and employee data are identified. The data may be automatically obtained, for instance, from existing databases or other storage devices, for example, that store past project information and employee performance data. At 104, various patterns are identified in team member attributes that are correlated with individual and project success. Examples of patterns may include, but are not limited to, complementary job roles or skills, extended time on teams together, publishing or patenting together, common education or training, or in common prior groups, committees, or organizations These patterns apply to multiple individuals or the project team as a whole rather than to just individuals on the team. Any known or will be known data mining or statistical methods, may be used to identify or determine the patterns. Other pattern recognition or matching methodologies may be used to identify various patterns that are characteristic of a successful individual, team and/or project.

At 106, the derived patterns are used to generate staffing decisions or form high-performing teams for new projects given potential team member attributes, subject to constraints. Team member attributes may include, for example, experience with clients, job role, competencies, educational background, gender, certifications, work experience, etc. Example constraints may include such items as requiring at least one team member to be certified in project management, requiring fewer than 50% of the team members to have less than 2 years experience, etc.

In one embodiment of the present disclosure, identifying patterns in workers' or team member attributes that are correlated with project success may involve project classification analysis, based on predefined criteria, to determine which projects are “successful” or not, or label projects according to different degrees of success. Criteria for assessing the success of a project may include, but are not limited to, profitability of the project, client satisfaction with the project, “revenue pull-in factor”, etc. Examples of profitability of a project may include, but are not limited to, profit margin or profit margin normalized with the respect to the average in similar projects. Examples of client satisfaction with the project may include, but are not limited to, client satisfaction scores or client satisfaction scores normalized with respect to the average in similar projects. Examples of revenue pull-in factor may include, but are not limited, to additional revenue generated throughout or as a result of the project.

The method and system of the present disclosure in one embodiment may use past workforce information such as level of education, job category, job role, profession, language fluency, skills, personality classification, performance ratings, reputation measures, or industry specialization and historical project assignments to identify attributes of the team members and/or teams that were common for successful or failed groups or classifications of projects. Examples of historical project assignments may include, but are not limited to, the list of people who were assigned to the same project, those who actually logged hours to get compensation related to the project, or those who undertook joint activities as part of the project such as papers, patents, products delivered to clients, etc. Examples of projects may include but are not limited to sales projects, service engagements with large clients, or laptop maintenance projects.

In one embodiment, discovered relationships or patterns in the form of correlations, associations, and/or association rules may be configured or used as feedback, for example, as constraints, into an optimization methodology to determine optimal job assignments, or to form optimal teams to satisfy the workforce demand. Examples of correlations may include but are not limited to the following: education level of the group is correlated with profitability; members in teams together in the past might be correlated with efficiency, utilization and profitability; adding “new” employees to a “seasoned” team might be correlated with accelerated carrier growth. An example of associations may include but is not limited to: fluency of the group in a common language is associated with productivity. An example of association rules may include but is not limited to: certain combinations of skills might produce more successful projects and/or relationships. Another example may be a constraint that at least some team-forming relationships are satisfied, such as requiring that the team leader has worked with all of the team members in the past

The method and system of the present disclosure in one embodiment also may identify patterns in teams that correlate to individual team member success. In an example embodiment, a methodology can be configured to use past workforce information and historical project assignments to identify attributes of the team members in a team that led to successful career development or personal growth.

In another embodiment, the discovered patterns can be used as input to scheduling and job assignment tools. In yet another embodiment, these discovered patterns can be used as constraints in an optimization tool, which computes “optimal” workforce policies, or identifies solutions for training employees to meet job requirements and/or switching jobs to meet anticipated demand (“upskilling”). Examples constraints based on some discovered patterns that can be used in scheduling and optimization tools include but are not limited to: 1) enforcing that people who have successfully worked in the past remain on the same projects in the future, 2) enforcing that people who have certain combination of skills are placed together in a team, or 3) enforcing that at least some new members are added to already matured teams, etc. The above constraints are developed, for example, based on a pattern discovered that shows a certain group of people who work together being successful, a certain combination of skill set in a group of people working together proved to be successful, or a combination of certain skill levels in a team was successful, etc. In an optimization setting such as constrained linear, non-linear optimization or integer-programming, these rules would be specified as a constraints, so that a predefined objective function is minimized subject to satisfying these constraints.

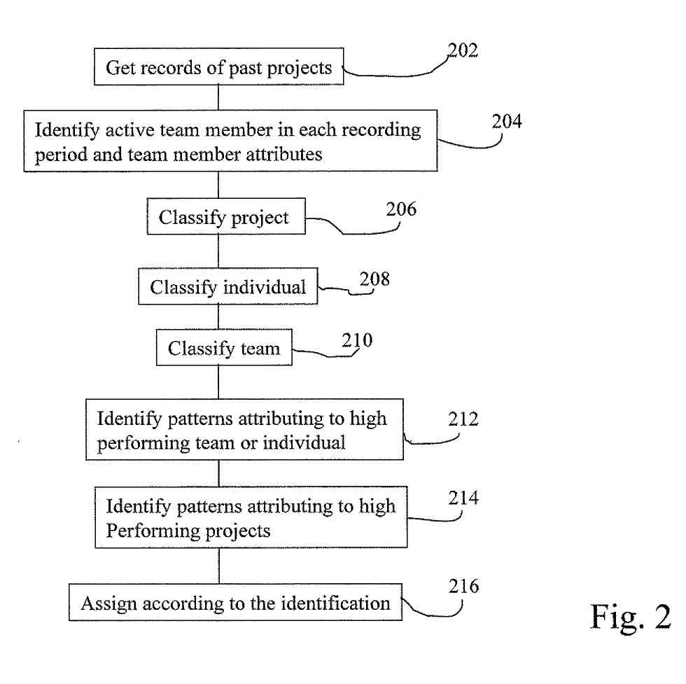

FIG. 2 is a flow diagram illustrating a method of the present disclosure in one embodiment. At 202, records of past projects are retrieved. Records may include the amount of time, for example, the number of hours, that each team member may have put into each project during each recording period (day, week, month, etc.) and other information. At 204, for each project at each recording period, the method in one embodiment identifies the team members active in that period and identifies a set of attributes characterizing each team member. Examples of attributes characterizing a team member may include, but are not limited to, experience with clients, job role, competencies, educational background, gender, certifications, work experience, job evaluations, or other factors.

At 206, each project may be classified according to its performance along one or more dimensions, including, but not limited to, client satisfaction and profit. In addition, or alternatively, at 208, each individual may be classified according to the individual's performance along one or more dimensions. Examples of such individual classification may include, but are not limited to, “fast advancer”, “slow advancer”, “on the learning curve”, “under performance improvement plan”, or other similar individual performance categories. At 210, each team may be classified according to its performance along one or more dimensions, including, but not limited to, “outperform”, “perform”, “average”, “underperform”, “failed”, or other similar team performance categories. The above-described classifications are provided as examples only, and it should be understood that additional classifications or not all of the above-described classifications may be used in implementing the method of the present disclosure.

At 212, the method in one embodiment may identify patterns of team member and project attributes common to high performing teams or individuals. In one embodiment, the method of the present disclosure may utilize mathematical algorithms to identify the patterns. An example of a pattern may be: teams where at least 50% of team members have worked together before are more likely to be successful than others. Examples of mathematical algorithms used may include, but are not limited to: Classification trees, Cluster analysis, Support vector machines, and Network analysis. Briefly, classification trees are commonly used for data mining; cluster analysis includes a number of different methods for grouping objects of similar kind into categories; support vector machines include learning methods used for classification; network analysis uses networks in pattern recognition. Other analysis methods may be used to identify patterns in the method and system of the present disclosure.

At 214, the method may, alternatively or in addition, identify patterns of team member and project attributes common to high performing projects. Examples of mathematical algorithms used may include, but are not limited to: Classification trees, Cluster analysis, Support vector machines, Network analysis. An example of a pattern may be: projects staffed at “20% Band 8, 50% Band 7 and 30% Band 6” are more successful than projects staffed at “50% Band 8, 30% Band 7 and 20% Band 6”, where Band numbers indicate different seniority levels of employees. At 216, the method may assign the set of employees having attributes identified as indicators of a high performing team to a new project, or use them in other workforce management processes or software applications, for example, scheduling, capacity planning, etc., so as to satisfy an identified objective subject to a set of constraints. Examples of a set of constraints may include, but are not limited to, minimizing bench time, maximizing profit, maximizing client satisfaction while enabling career development for team members, etc. Identified attributes may be used, for example, in a human resource (HR) software application to help understand what attributes should be advertised and where to put emphasis in programs for employee/team development. Identified attributes may be also used, for example, as a component of workforce management tools, applications, or solutions. An example is a scheduling tool, which is often used in project delivery to determine optimal staffing. Such tools can be reconfigured or rebuilt to take into account “team-formation” rules derived from patterns of high performance. By conducting the project staffing in such a way, the likelihood of having more successful projects in the future is significantly increased.

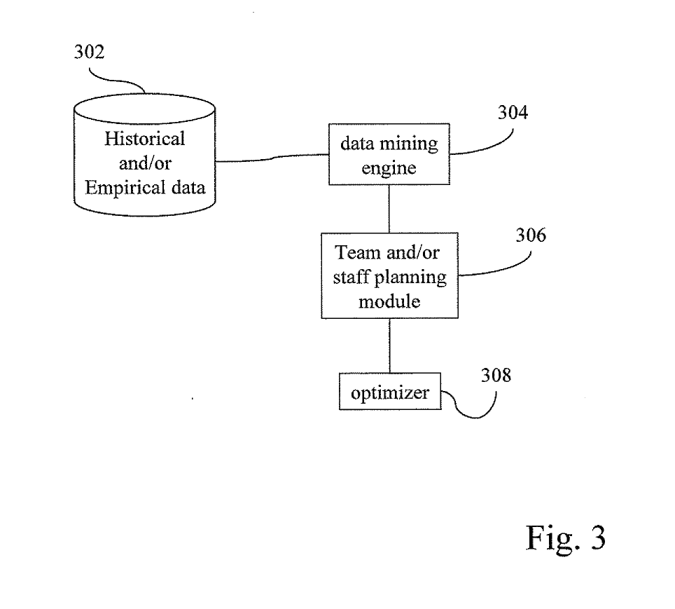

FIG. 3 illustrates an overview of example system architecture for identifying and using historical work patterns to build high-performance project teams. A data mining engine 304 may retrieve historical and/or empirical data 302 and extract patterns that correlate attributes of individuals, team members, teams, and/or projects that are classified as being successful. The historical and/or empirical data 302, for instance, may be stored in any know or will be known storage devices or utilities, including but not limited to, optical discs, magnetic storage, hard disks, solid state storage, network storage devices, etc. A staff planning module 306 assigns one or more individuals to a project based on the patterns determined in the data mining engine. In addition to using the patterns and attributes discovered in the patterns for assignments, such information can also be used for training purposes, career development, human resource development, etc. A staff planning module 306 may use an optimizer 308, for instance, by inputting the discovered patterns and/or attributes as constraints to the optimizer 308, for the optimizer 308 to automatically compute an optimal staff assignments subject to the input constraints. The data mining engine 304, the staff planning module 306, and the optimizer 308 may be implemented in one or more computer processors or processing units, and may be implemented as software, firmware, hardware circuitry, etc. The components 304, 306 and 308 may reside in one computing unit locally or may be distributed among remote units communicating via one or more communication networks.

The system and method of the present disclosure may be implemented and run on a general-purpose computer or computer system. Various functionalities described above may be implemented as a module in a computer and, for example, executable by a processor. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for identifying and using historical work patterns to build high-performance project teams, comprising:
identifying historical data associated with one or more past projects;
determining from said historical data, one or more patterns in team member attributes that are correlated with an individual determined to be successful or a project determined to be successful or combinations thereof; and
generating one or more staffing plans based on said determined patterns.

2. The method of claim 1, wherein said determining further includes classifying a plurality of projects to determine success level associated with the plurality of projects.

3. The method of claim 2, wherein said determining further includes identifying one or more patterns in attributes of team members involved in one or more of said plurality of projects determined to be successful.

4. The method of claim 2, wherein said determining further includes identifying one or more high performing teams and one or more patterns of team member attributes in said high performing teams.

5. The method of claim 1, wherein said identifying includes identifying one or more attributes characterizing each individual involved in said one or more projects.

6. The method of claim 1, wherein said determining is performed using mathematical analysis.

7. The method of claim 1, said determining is performed using at least one of classification trees, cluster analysis, support vector machines, network analysis.

8. The method of claim 1, wherein said determined patterns are used as feedback into an automatic planning optimizer.

9. The method of claim 1, wherein the generating step includes providing said determined patterns as constraints into an optimization algorithm, wherein the optimization algorithm outputs an optimized staffing plan based on the constraints.

10. A system for identifying and using historical work patterns to build high-performance project teams, comprising:
means for identifying historical data associated with one or more past projects;
means for determining from said historical data, one or more patterns in team member attributes that are correlated with at least one of an individual determined to be successful and a project determined to be successful; and
means for generating one or more staffing plans based on said determined patterns.

11. The system of claim 10, wherein said means for determining is operable to classify a plurality of projects to determine their success level.

12. The system of claim 11, wherein said means for determining is operable to identify one or more patterns in attributes of team members involved in one or more of said plurality of projects determined to be successful.

13. The system of claim 10, wherein said means for determining is operable to identify one or more high performing teams and one or more patterns of team member attributes in said high performing teams.

14. The system of claim 10, wherein said identifying includes identifying one or more attributes characterizing each individual involved in said one or more projects.

15. A program storage device readable by a machine, tangibly embodying a program of instructions executable by the machine to perform a method of identifying and using historical work patterns to build high-performance project teams, comprising:
identifying historical data associated with one or more past projects;
determining from said historical data, one or more patterns in team member attributes that are correlated with an individual determined to be successful or a project determined to be successful or combinations thereof; and
generating one or more staffing plans based on said determined patterns.

16. The program storage device of claim 15, wherein said determining further includes classifying a plurality of projects to determine their success level.

17. The program storage device of claim 16, wherein said determining further includes identifying one or more patterns in attributes of team members involved in one or more of said plurality of projects determined to be successful.

18. The program storage device of claim 17, wherein said determining further includes identifying one or more high performing teams and one or more patterns of team member attributes in said high performing teams.

19. The program storage device of claim 15, wherein said identifying includes identifying one or more attributes characterizing each individual involved in said one or more projects.

20. The program storage device of claim 15, wherein the generating step includes providing said determined patterns as constraints into an optimization algorithm, wherein the optimization algorithm outputs an optimized staffing plan based on the constraints.
